(19) United States
(12) Patent Application Publication
(10) Pub. No.: US 2013/0247393 A1
(43) Pub. Date: Sep. 26, 2013

(54) Disposable Safety Razor

(71) Applicant: Thomas Michael Poladian, Dearborn, MI (US)

(72) Inventor: Thomas Michael Poladian, Dearborn, MI (US)

(21) Appl. No.: 13/783,350

(22) Filed: Mar. 3, 2013

Related U.S. Application Data
(60) Provisional application No. 61/609,281, filed on Mar. 10, 2012.

(51) Int. Cl. B26B 21/06; B26B 21/52

(52) U.S. Cl. CPC B26B 21/06; B26B 21/522
USPC 30/526; 30/32

(57) ABSTRACT

A disposable razor having a razor blade with a width substantially narrower than that of any conventional disposable razors comprising of a rigid inner core handle for gripping, formed of thermoplastic material with a compatible rubber co-extrudable layer on the back side concave finger-rest and on the left and right side palm-rests. That portion of the razor blade that makes contact with the skin (the grind) has no encasing side borders allowing it to extend to within 0.7 millimeters (mm) of the sides of the razor's head. The rubberized portions on the handle provide for a secure grip in all shaving conditions including wet and soapy. The razor's symmetry, measured from the frontal center axis allows for the razor to be used with equal ease and effectiveness for a wide range of hand sizes whether the user is right or left handed.

### RELATED APPLICATIONS

This utility patent application claims priority to the following patent application that is also hereby incorporated by reference in its entirety: the provisional patent application titled “SINGLE-EDGE DISPOSABLE SAFETY RAZOR (Ser. No. 61/609,281) that was filed on Mar. 10, 2012.

### BACKGROUND OF THE INVENTION

This invention relates to hand held, single-edge disposable razors and, more particularly to a novel, highly effective single-edge disposable safety razor that due to its narrow head size and narrow razor blade width is very effective and efficient in safely removing unwanted facial hair from specific areas of the face, specifically under the lower lip and chin area allowing the user the ability to safely leave the facial hair they would like to keep.

Current conventional disposable razors, due to their wider head size and wider razor blade width are a means of removing unwanted hair over larger surface areas of the face and body where hair is known to grow, that is the user of a conventional disposable safety razor and safety razors in general can remove unwanted facial hair or androgenic hair in the shortest amount of time.

One major drawback of conventional single-edge disposable razors, multi-edged razors and razors in general is that they give no consideration, due to their overall width, to men who would like finer detailed bordering or edging between bare skin and facial hair they would like to keep. This current “one blade size fits all” for all facial hair styles approach with conventional single blade and multi-blade disposable razors is that they do not take into consideration specific areas of the face or style of design a person may want to achieve. A man growing out his facial hair has always been a part of him expressing his individuality, masculinity and sense of fashion. Styling of facial hair and the spectrum of thickness is an important part of men's grooming and seems to be more prevalent than in years past and this invention allows for men to safely remove facial hair while keeping the facial hair they would like to keep in and around the chin area. Unlike full bearded men, many men keep their whiskers trimmed close to the face and allow for stubble to not only grow, but keep it well managed and maintained. This invention solves the problem and limitations that are inherent with conventional disposable safety razors and safety razors in general in use today and simply allows men another personal grooming option.

The wider head widths, wider blade widths and awkward handle shapes on conventional disposable razors limit the razors positioning for men who are trying to shave off facial hair around their chin area. Men with these conventional razors may have to resort to awkwardly maneuvering the razor by twisting it and turning it vertically in order to access tighter areas under the lower lip and chin and still not able to achieve the desired result; Not only are they unsuccessful, but frustrated and increase their risk of a facial nick or cut.

Furthermore, single blade disposable razors, multi-blade disposable razors and multi-blade razors with replaceable blade units have side borders which encase the side edges of their blades making facial hair detailing unobtainable or at the very least much more difficult as a person would have to overlap the razor's border into the facial hair they would like to keep which does not allow them the ability to keep the razor flat against their skin. In order for disposable razors and safety razors in general to remain safe the entire razor blade must remain flat against the skin. If the user needs to tilt or lift a portion of their conventional razor off the skin, safety is compromised. Also, the user of a conventional disposable razor cannot see just where the edge of the blade actually is on the face which makes finer detailing a “trial and error” type method and the user can run the risk removing hair they would like to keep.

Furthermore, conventional single blade disposable razors, multi blade disposable razors and safety razors with replaceable blades incorporate primary shaped handles such as round or square which can cause awkwardness, discomfort or unwanted slipping or rotation. These handles on conventional disposable safety razors do not take into consideration men with larger hands and larger fingers.

### SUMMARY OF THE INVENTION

An object of this invention is to provide a safe, effective disposable razor that remedies all of short comings listed above with conventional disposable razors and razors in general.

In particular an object of the invention is to provide a disposable safety razor having a blade width of only 8 mm which is substantially narrower than that of conventional disposable single-edge safety razors and multi-edge razors with replaceable blade units.

Furthermore, an object of this invention is to provide a disposable razor free of limiting side borders for that portion of the blade that makes contact with the skin.

Furthermore, an object of this invention is to provide a disposable safety razor with an ergonomic rigid inner core handle. Said handle is comprised of thermoplastic having a compatible rubber layer coextrudable for enhancing grip, resistance to slipping and giving the user much more control and stability around the chin area. Said handle is resistant to unwanted rotation in all shaving conditions including wet and soapy and is much easier to accommodate a wide range of hand sizes, finger sizes and gripping techniques.

The foregoing and other objects are attained in accordance with the invention providing a hand held, disposable razor with a head that comprises: 1) at least one razor blade, 2) a razor blade platform, 3) a razor blade housing, 4) a top cover which covers the blade except that portion that makes contact with the skin, 5) a blade guard which is the front portion of the razor supported on each of the sides by, 6) a left blade guard support arm, 7) a right blade guard support arm.

### BRIEF DESCRIPTION OF THE DRAWINGS

A better understanding of the invention may be gained from considering the following detailed description of the preferred embodiments thereof, in conjunction with the appended figures of the drawings, wherein:

FIG. 1 Right perspective view of invention

FIG. 2 Front side view of invention

FIG. 3 Rear side view of invention

FIG. 4 Left side view of invention

FIG. 5 Right side view of invention

FIG. 6 Enlarged head view

FIG. 7 Exploded head view of FIG. 6

FIG. 8 Enlarged right side view of head

FIG. 9 Section view of FIG. 6

Throughout the Figures of the drawings the same reference numerals or characters are used to denote like components or features of the illustrated razor.

10—disposable safety razor

11—cover plate

12—razor blade

14—razor blade guard

15—razor's handle

16—right support arm for blade guard

17—razor's head

18—left support arm for blade guard

20—back side finger rest with rubber layer

21—right side palm rest with rubber layer

22—left side palm rest with rubber layer

23—razor blade alignment pin

24—razor blade platform

25—upper portion of handle right side

26—upper portion of handle left side

27—razor blade retaining walls

### DETAILED DESCRIPTION OF THE INVENTION

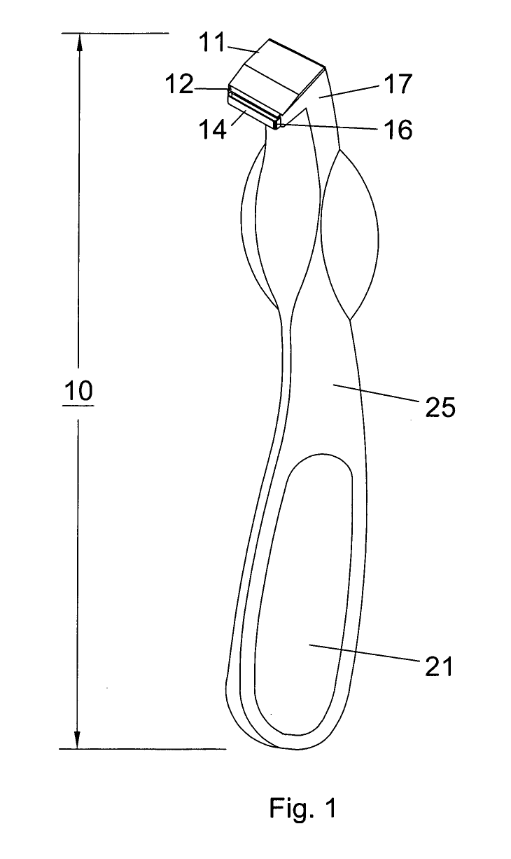

Referring to figure FIG. 1, there is shown a right perspective view of an exemplary disposable razor 10 in accordance with the invention made of thermoplastic material. The narrow shaving head 17 is of non conventional dimension carrying one or more non-detachable razor blades 12 which, and at only 7.5 mm wide is much narrower than conventional blades. Also, the blade has no encasing side borders at the skin contact edge and an ergonomic thermoplastic handle with palm rests 21 made of a compatible rubber layer coextrudable.

The razor's handle is of suitable length having a solid thermoplastic inner core giving the razor increased rigidity with the rear side, lower left side and lower right side portions covered by a relatively thin, flexible layer of coextruded thermoplastic rubber covering 20, 21, 22. Advantageously, the elongated handle is formed to have these wide palm rests in order to accommodate a wide range of hand sizes and gripping styles in various shaving conditions. The thermoplastic handle must be sufficient to provide substantial rigidity and will depend upon the characteristics of the material. Suitable thermoplastic materials for forming the razor are various and can include polyolefins (including polyethylenes, such as high density polyethylenes, and polypropylene).

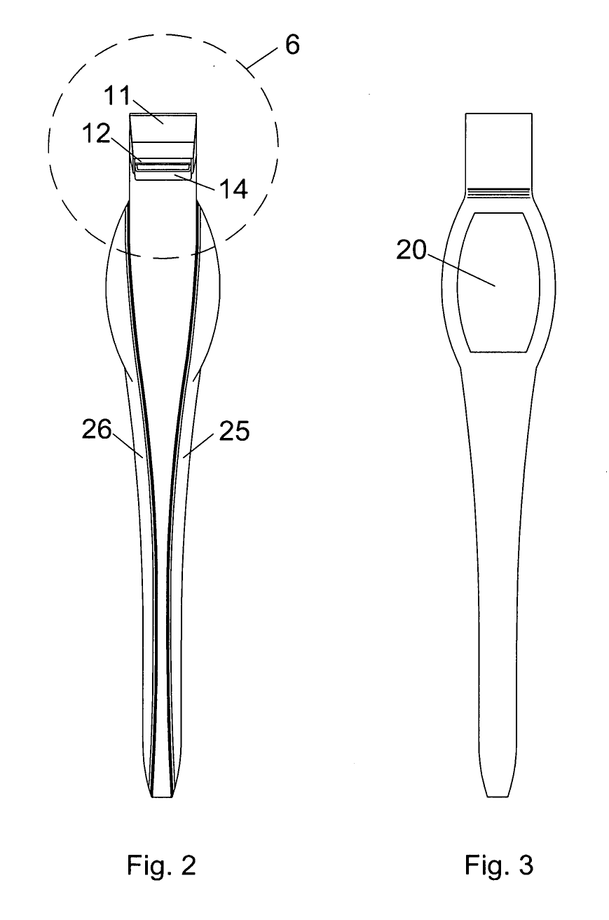

Turning now to the details of FIG. 2 which is a front side view of the razor showing the curvature of the front upper portions of the handle 25, and 26. Continuing with FIG. 2. This also shows the blade safety guard 14 which is the front most part of the razor and keeps the razor blade from penetrating the surface of the skin. The razor blade 12 is fixed into position on the blade platform and within the blade housing with the cover plate (cap) 11 covering the razor blade 12 except for the grind. FIG. 3 is the rear side view of razor showing the back side of the razor with a wide concave rubber layer finger rest 20 below the razor's head.

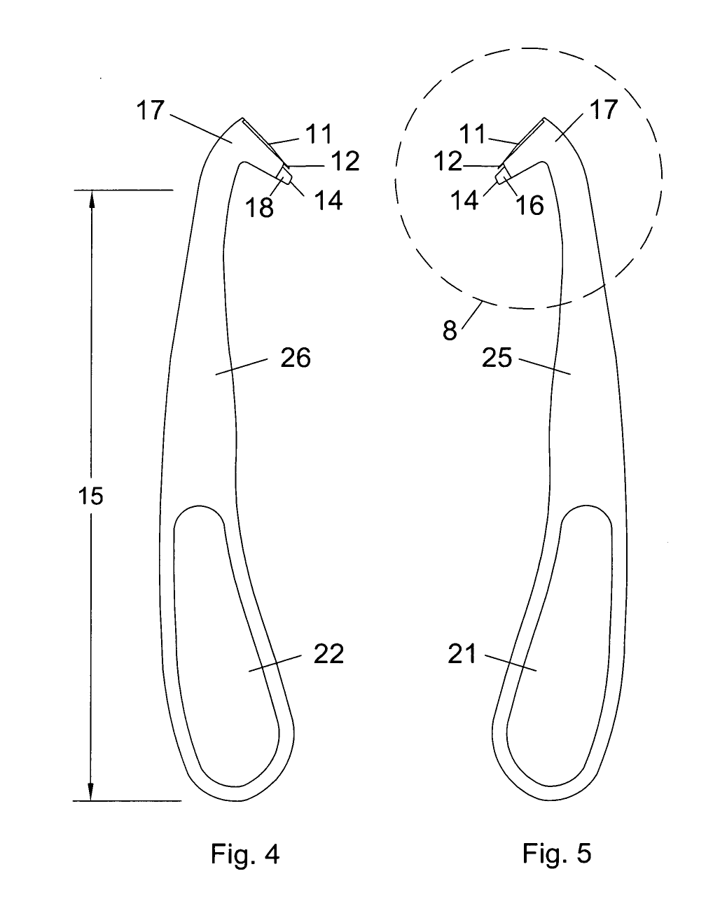

Turning to FIGS. 4 and 5 showing the left and right side profiles. Since the razor's handle 15 is not round, a diameter cannot be measured. The front to rear measurement changes from top to bottom with the narrowest point measuring 6.62 mm under the razor's head and measuring 20.10 mm at the razor's widest point near the bottom of the handle. Once past the razor's widest point the handle begins to briefly narrow down again approaching the bottom of the handle.

The razor's lower portion of the handle incorporates wide thermoplastic rubberized palm rests on both the left side 22 and right side 21. This wide surface area at the lower portion of the handle with the rubber layer provides for a twofold purpose. First, providing for a secure palm rest and second, a secure finger pinch hold. The rubber layer on the handle 21, 22 which may have any thickness capable of being formed by the coextrusion process provides those portions with a non-slippery feel, even when held by a wet and soapy hand even if the razor is pinched between the thumb and index finger should the user decide to use it in that manner.

In the exemplary embodiment of the razor in FIGS. 1, 2, 3, 4, and 5 the razor has a total top to bottom length of 116 mm (11.6 cm)

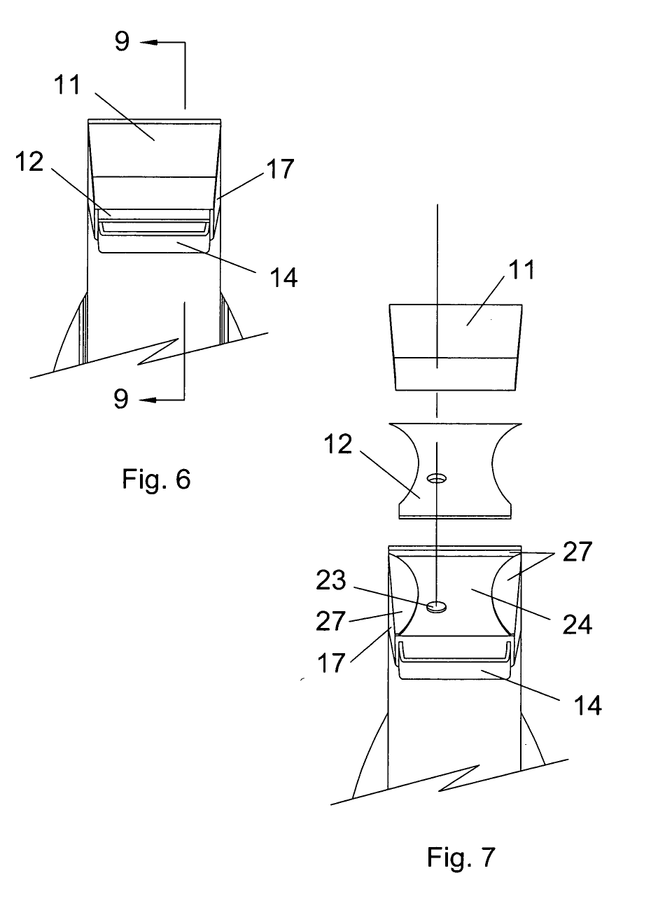

Turning to FIGS. 6 and 7. FIG. 6 shows an enlarged view of the razor's head 17. Details include: the razor blade guard 14 (the forward most part of the razor), the razor blade 12, the cover plate (cap) 11 covering the razor blade within the housing, the horizontal line on the cap represents a change in pitch sloping downward towards the blade to a point becoming so thin as not to interfere with the effective cutting edge of the blade. FIG. 7 is an exploded view of FIG. 6. FIG. 7 shows the actual shape of the entire razor blade 12 including the grind (that portion of the blade that makes contact with the skin), the side semi-circles, the alignment hole measuring 2.45 mm in diameter, the razor blade platform and its shape with alignment pin 23 measuring 2.60 mm 24 (the platform is what the blade sits on top of within the housing). The three retaining walls 27 are at 90° to the blade platform. This 90° angle is to ensure that the razor blade is fixed into position and not allow for the razor blade to cradle within the housing.

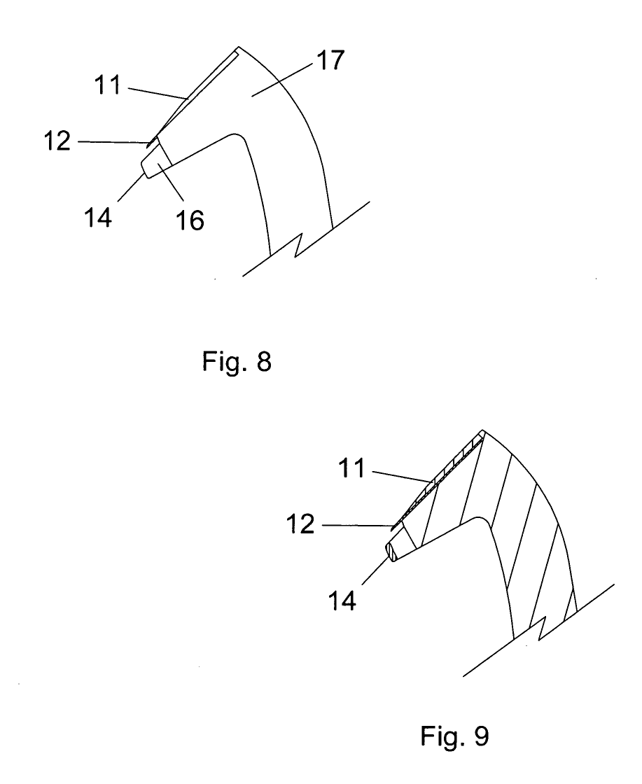

Turning to FIGS. 8 and 9. FIG. 8 is an enlarged right side view of the razor's head 17. The cap 11 with the blade 12 shows the pitch angle of the cap decreasing towards the front portion of the blade. This gradual change cap thickness tapers towards the front of the blade as not to allow the blade to be hindered or interfered with by the maximum thickness of the cap. Once the blade makes contact with the face the decreasing pitch change provides the grind to be free of a potential obstruction from the cap and allows for the user to gain the maximum effectiveness of the razor. FIG. 9 is a section view of FIG. 6. It shows the solid inner core and specific components of the razor. That portion not having cross section hatching immediately behind the blade guard 14 is the inner side of left blade guard support arm.

While the invention has been described in terms of the forgoing specific embodiment thereof, it will be apparent to those skilled in the art that various alterations and modifications may be made to the described embodiment without departing from the scope of the invention, as defined by the appended claims.

What is claimed is:

1) A disposable razor comprising of a head width substantially narrower than that of conventional disposable safety razors and safety razors in general, having a thermoplastic handle with portions of a compatible rubber layer coextrudable and at least one non detachable razor blade mounted and fixed into position within the head and on top of the handle for movement relative thereto allowing for the following of movements on specific areas of the face.

2) A disposable razor according to claim 1 wherein the said head is comprised of (1) at least one razor blade, (2) a razor blade housing including a blade platform having a blade locator reference, two side walls and one rear wall, (3) a razor blade cover plate, (4) a razor blade safety guard, (5) a right safety guard support arm, (6) a left safety guard support arm.

3) A disposable razor according to claim 1 having a razor blade wherein the edge of the blade that makes contact with the skin (the grind) is free of side borders.

4) A disposable razor according to claim 1 having handle comprising of a wide concave finger rest on the backside below the razor's head and substantially wide palm-rests on both sides.

5) A disposable razor according to claim 1 wherein said portion of the blade width making contact with the skin (the grind) is within the range of 4 mm to 15 mm.

6) A disposable razor according to claim 1 wherein said portion of the blade width making contact with the skin (the grind) is substantially 7.5 mm.

7) A disposable razor according to claim 1 wherein has substantially wide palm-rests on both sides having a compatible rubber layer coextrudable for enhancing the razor's stability, controllability, grip and for resting that portion of the users palm below the base of the thumb.

8) A disposable razor according to claim 1 wherein the razor's overall length is within the range of 100 mm to 120 mm (10.0 cm to 12.0 cm).

9) A disposable razor according to claim 1 wherein the razor's length is substantially 116 mm (11.6 cm).

10) A disposable razor according to claim 1 wherein the razor's rear side concave finger rest is within the range of 15 mm to 25 mm.

11) A disposable razor according to claim 1 wherein the razor's rear side concave ringer rest is substantially 20 mm.
